(19) United States
(12) Patent Application Publication
(10) Pub. No.: US 2024/0315195 A1
(43) Pub. Date: Sep. 26, 2024

(54) MODULAR ANIMAL CRATE

(71) Applicant: Diggs Inc., Long Island City, NY (US)

(72) Inventors: Isaac Haverlick, Jersey City, NJ (US); Gregory Hoge, Ridgewood, NY (US); Zel Alexander Crampton, Brooklyn, NY (US); Courtney Armstrong, Astoria, NY (US); Lilly Althauser-Benson, Brandon, FL (US)

(21) Appl. No.: 18/124,417

(22) Filed: Mar. 21, 2023

(51) Int. Cl. A01K 1/03; F16B 5/06

(52) U.S. Cl. CPC A01K 1/033; F16B 5/0614; F16B 2005/0678

(57) ABSTRACT

A modular animal crate assembly including a first side panel having a door; a second side panel, a third side panel, a fourth side panel, a fifth side panel, and a sixth side panel; where the first side panel, the second side panel, the third side panel, the fourth side panel, the fifth side panel, and the sixth side panel are coupled together to form the modular animal crate assembly; a first assembled state; and a second assembled state; where the first side panel is positioned on a first side of the modular animal crate assembly in the first assembled state; and the first side panel is positioned on a second side of the modular animal crate assembly in the second assembled state.

### TECHNICAL FIELD

The present disclosure relates to the pet industry generally and more specifically to animal crates.

### BACKGROUND

Conventional enclosures or crates for pets are often heavy, difficult to operate, e.g., hard to deploy and/or collapse, and not user/pet friendly, e.g., having multiple potential entrapment and/or pinching hazards. In addition, conventional pet enclosures are disadvantageous because the door positions and opening direction of the door(s) are often fixed, which can limit the locations in which the conventional pet enclosures can be used.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments of the present disclosure, a modular animal crate assembly includes a first side panel having a door; a second side panel, a third side panel, a fourth side panel, a fifth side panel, and a sixth side panel; where the first side panel, the second side panel, the third side panel, the fourth side panel, the fifth side panel, and the sixth side panel are coupled together to form the modular animal crate assembly; a first assembled state; and a second assembled state; where: the first side panel is positioned on a first side of the modular animal crate assembly in the first assembled state; and the first side panel is positioned on a second side of the modular animal crate assembly in the second assembled state.

According to certain embodiments of the present disclosure, a modular animal crate assembly includes a front side panel having a first door with a door opening mechanism; a rear side panel; a right side panel having a second door; a left side panel; a top side panel; a bottom side panel; a first assembled state, wherein, in the first assembled state, the front side panel is positioned on a front side of the modular animal crate assembly, the door opening mechanism is positioned at a first edge of the front side of the modular animal crate assembly, and the right side panel is positioned on a right side of the modular animal crate assembly; and a second assembled state, wherein, in the second assembled state, the front side panel is positioned on a front side of the modular animal crate assembly, the door opening mechanism is positioned at a second edge of the front side of the modular animal crate assembly, and the right side panel is positioned on a left side of the modular animal crate assembly.

According to certain embodiments of the present disclosure, a method of assembling a modular animal crate assembly that includes a first side panel; a second side panel, a third side panel, a fourth side panel, a fifth side panel, a sixth side panel, and a corner connector, the method including positioning the first side panel, the second side panel, and the third side panel adjacent to one another to form a corner joint; inserting at least a first portion of the corner connector through an opening in the corner joint; and rotating at least a second portion of the corner connecter to couple the corner connector to the corner joint.

### BRIEF DESCRIPTION OF THE DRAWINGS

The specification makes reference to the following appended figures, in which use of like reference numerals in different figures is intended to illustrate like or analogous components.

FIG. 1 is a front perspective view of a modular animal crate assembly according to certain aspects of the present disclosure.

FIG. 2 is an exploded view of the modular animal crate assembly of FIG. 1.

FIGS. 3A and 3B are perspective views of the modular animal crate assembly of FIG. 1 with the side panels arranged in two different orientations.

FIG. 4 is a perspective view of the modular animal crate assembly of FIG. 1 disassembled.

FIG. 5 is a process flow schematic for assembling a corner of a modular animal crate assembly according to certain aspects of the present disclosure.

FIGS. 6A and 6B are exploded views of a corner connector of a modular animal crate assembly according to certain aspects of the present disclosure.

FIG. 7 is a process flow schematic for assembling a corner of a modular animal crate assembly according to certain aspects of the present disclosure.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

As used herein, directional and spatial terms such as “right,” “left,” “top,” “bottom,” “front,” “rear,” “horizontal,” “vertical,” “horizontally,” “vertically,” and “upward” are not intended to be binding terms.

Certain aspects and features of the present disclosure relate to modular animal crates. The embodiments of the present disclosure described below are not intended to be exhaustive or to limit the disclosure to the precise forms described herein. Rather, the embodiments described herein are chosen so that a person of skill in the art can appreciate and understand the principles and practices of the present disclosure.

In an illustrative example, a modular animal crate may be formed from six side panels, e.g., a front side panel, a rear side panel, a right side panel, a left side panel, a top side panel and a bottom side panel. The six side panels may each be separate panels that are coupleable to each other to form the modular animal crate. The front side panel and the right side panel may each include a door that permits access to the interior of the assembled modular animal crate.

The different side panels may be arranged in different positions when assembling the modular animal crate. For example, the front side panel and door and the rear side panel positions may be switched so that the front side panel and door are in the rear position of the assembled modular animal crate. The ability of the user to choose the positioning of the side panels and doors enables the assembled modular animal crate to be customized by the user to best fit the available space where the modular animal crate will be used. The various side panels may be rearranged and swapped with any side panels of the same size. For example, the right side panel and door may be arranged on the left side or top side of the assembled animal crate based on the needs of the user.

Eight corner connectors may be used to couple the various side panels together to assemble the modular animal crate. Each corner connector may include extension portions that extend at least partially along the edge frames of abutting side panels. For example, the corner connector coupling the front side panel, the right side panel, and the top side panel together may include at least three extension portions. A first extension portion extends and at least partially covers a right edge of the front side panel and a left edge of the right side panel. A second extension portion extends and at least partially covers a top edge of the right side panel and a right edge of the top side panel. A third extension portion extends and at least partially covers a front edge of the top side panel and a top edge of the front side panel. These extension portions assist in securing the various side panels of the assembled modular animal crate and reduce the ability of animal being able to separate and push through the edges of the various side panels when contained withing the modular animal crate.

Each corner connector may have at least two pieces that are moveable relative to one another and provide easy assembly and disassembly of the modular animal crate. The first piece of the corner connector may be positioned at a joint between three adjacent side panels, e.g., the front side panel, the right side panel, and the top side panel, to hold the three adjacent side panels in the correct position relative to one another. The second piece of the corner connector may then be rotated, e.g., in a first direction, relative to the first piece of the corner connector and the three adjacent side panels to couple and securely lock the three adjacent side panels together. In the coupled position, the extension portions of the corner connector align with the respective edges of the three adjacent side panels.

To disassemble the modular animal crate, the second piece of the corner connector may be rotated, e.g., in a second direction opposite to the first direction, relative to the first piece of the corner connector, and the first piece of the corner connector may be removed from the joint between the three adjacent side panels. Each of the side panels and the corner connectors are completely separable from one another so that the pieces of the disassembled modular animal crate may be stored laying flat on top on one another.

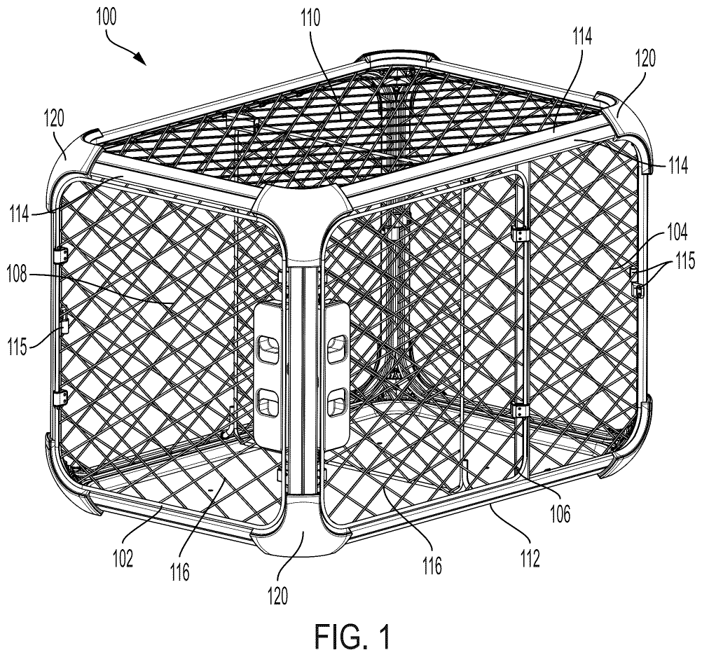

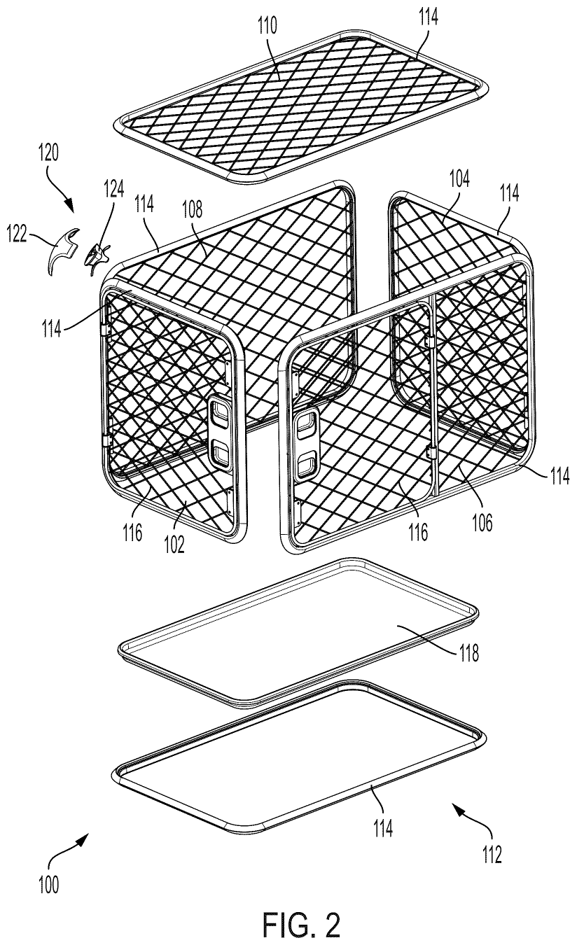

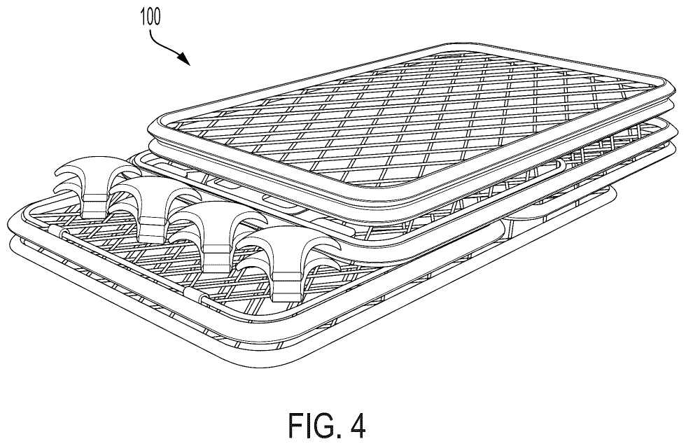

Described are various embodiments of a modular animal crate assembly 100 as shown in FIGS. 1-4. The modular animal crate assembly 100 is designed to be safer and more comfortable for the dog, more visually appealing in a user's home, and customizable with different orientations to enable a user to choose which orientation works best for the space where the modular animal crate assembly 100 will be used.

The modular animal crate assembly 100 comprises a front side panel 102, a rear side panel 104, a right side panel 106, a left side panel 108, a top side panel 110 and a bottom side panel 112. Though the modular animal crate assembly 100 is shown formed from six side panels, the modular animal crate assembly 100 may be formed from any suitable number of side panels, e.g., three, four, five, six, seven, eight, etc. For example, the modular animal crate assembly 100 may be assembled without the top side panel 110 and/or without the bottom side panel 112 to form a pen enclosure. The modular animal crate assembly 100 may form a triangular prism, a rectangular prism, a trapezoidal prism, a pentagonal prism, a hexagonal prism, etc.

Each side panel may be formed at least partially from a mesh network and a frame 114 at least partially surrounding the mesh network. The mesh network may include diamond shaped openings, rounded shaped openings, rectangular openings, or any other appropriate shape. In certain embodiments, at least a portion of at least one side panel may not be formed from a mesh network and may instead be formed from any other suitable material. For example, the bottom side panel 112 may be formed from a solid panel.

At least one side panel includes the frame 114 and/or a door 116. When assembled, the door 116 may be opened to provide access to the interior of the modular animal crate assembly 100 and may be closed to contain an animal within the modular animal crate assembly 100. In some embodiments, the door 116 may form an entirety of a side panel. In further embodiments, the door 116 may form only a portion of a side panel. Additionally, multiple side panels of the assembled modular animal crate assembly 100 may each include a door 116. For example, the front side panel 102 of the modular animal crate assembly 100 may include a frame 114 and a door 116 where the door 116 forms an entirety of the front side panel 102, and the right side panel 106 of the modular animal crate assembly 100 may include a frame 114, a door 116, and a stationary mesh network portion where the door 116 forms only a portion of the right side panel 106. The bottom side panel 112 may include a frame 114 and a removable tray 118 formed from a solid panel.

In some embodiments, each side panel includes at least one fastener 115 coupled to the frame 114. The at least one fastener 115 may be a screw, a nut and bolt, a rivet, a snap-fit button, adhesive, a zipper, a hook and loop fastener, a tie string, a magnet, a strap, a latch, a snap-fit connection, a friction-fit connection, etc. The at least one fastener 115 may be used to couple two adjacent panels together during the assembling of the modular animal crate assembly 100. For example, the front side panel 102 may have a first fastener 115 that is positioned to couple with a first fastener 115 of the right side panel 106. In certain embodiments, a portion of one of the first fastener 115 of the front side panel 102 or the first fastener 115 of the right side panel 106 is at least partially received in a portion of the other of the first fastener 115 of the front side panel 102 or the first fastener 115 of the right side panel 106 to form a snap-fit connection, a friction-fit connection, etc. between the first fastener 115 of the front side panel 102 or the first fastener 115 of the right side panel. For example, the first fastener 115 of the front side panel 102 may be a post and the first fastener 115 of the right side panel 106 may be a hollow body for receiving the post, or vice versa where the first fastener 115 of the right side panel 106 may be a post and the first fastener 115 of the front side panel 102 may be a hollow body for receiving the post. Coupling the side panels together using the at least one fastener 115 reduces the ability of an animal to push apart the side panels and escape when the animal is contained within the modular animal crate assembly 100.

In certain embodiments, some of the side panels may include two fasteners 115 coupled to the frame 114. For example, each of the front side panel 102, the rear side panel 104, the right side panel 106, and the left side panel 108 may include two fasteners 115 that couple the frames 114 of each adjacent side panel together. Additionally, the top side panel 110 and the bottom side panel 112 may have at least one fastener 115 coupled to the frame 114 that is coupleable to at least one of the adjacent side panels.

In some embodiments, the various side panels are coupled together using fasteners 115 and/or corner connectors 120 to form the modular animal crate assembly 100. The various side panels forming the modular animal crate assembly 100 may be rearrangeable. For example, the front side panel 102 and the rear side panel 104 may be the same size so that when assembling the modular animal crate assembly 100, the front side panel 102 may be positioned on a front side or a rear side of the modular animal crate assembly 100 and the rear side panel 104 may be positioned on a front side or a rear side of the modular animal crate assembly 100.

Additionally, the front side panel 102 may be positioned on a front side of the modular animal crate assembly 100 so that a door handle and locking mechanism of the door 116 is arranged at a first edge, e.g., a right edge, of the front side of the modular animal crate assembly 100, or the front side panel 102 may be positioned on a front side of the modular animal crate assembly 100 and may be rotated 180 degrees so that the door handle and locking mechanism of the door 116 is arranged at a second edge, e.g., a left edge, of the front side of the modular animal crate assembly 100. Depending on the dimensions of the front side panel 102, the front side panel 102 may be rotated at 90 degree increments so that the door handle and locking mechanism of the door 116 may also be arranged at a third edge, e.g., a top edge, or a fourth edge, e.g., bottom edge, of the front side of the modular animal crate assembly 100.

Further, the right side panel 106, the left side panel 108, the top side panel 110, and the bottom side panel 112 may each be the same size. So when assembling the modular animal crate assembly 100, the right side panel 106 may be positioned on a right side, left side, top side, or bottom side of the modular animal crate assembly 100, the left side panel 108 may be positioned on a right side, left side, top side, or bottom side of the modular animal crate assembly 100, the top side panel 110 may be positioned on a right side, left side, top side, or bottom side of the modular animal crate assembly 100, and the bottom side panel 112 may be positioned on a right side, left side, top side, or bottom side of the modular animal crate assembly 100.

Additionally, the right side panel 106 may be positioned on a right side of the modular animal crate assembly 100 so that a door handle and locking mechanism of the door 116 is arranged at a first edge, e.g., a right edge, of the right side of the modular animal crate assembly 100, or the right side panel 106 may be positioned on a right side of the modular animal crate assembly 100 and may be rotated 180 degrees so that the door handle and locking mechanism of the door 116 is arranged at a second edge, e.g., a left edge, of the right side of the modular animal crate assembly 100. Depending on the dimensions of the right side panel 106, the right side panel 106 may be rotated at 90 degree increments so that the door handle and locking mechanism of the door 116 may also be arranged at a third edge, e.g., a top edge, or a fourth edge, e.g., bottom edge, of the right side of the modular animal crate assembly 100. Though the embodiments discussed above refer to the front side panel 102 and the right side panel 106 and corresponding doors 116 in each, the various other side panels of the modular animal crate assembly 100 may be similarly rearranged and positioned when assembling the modular animal crate assembly 100 and may also include a door 116.

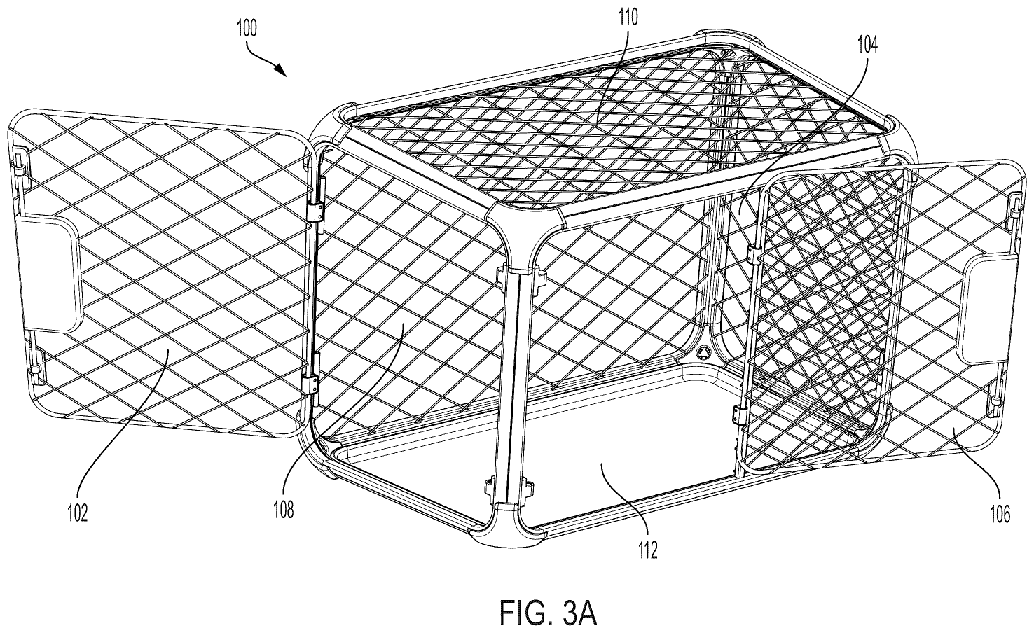

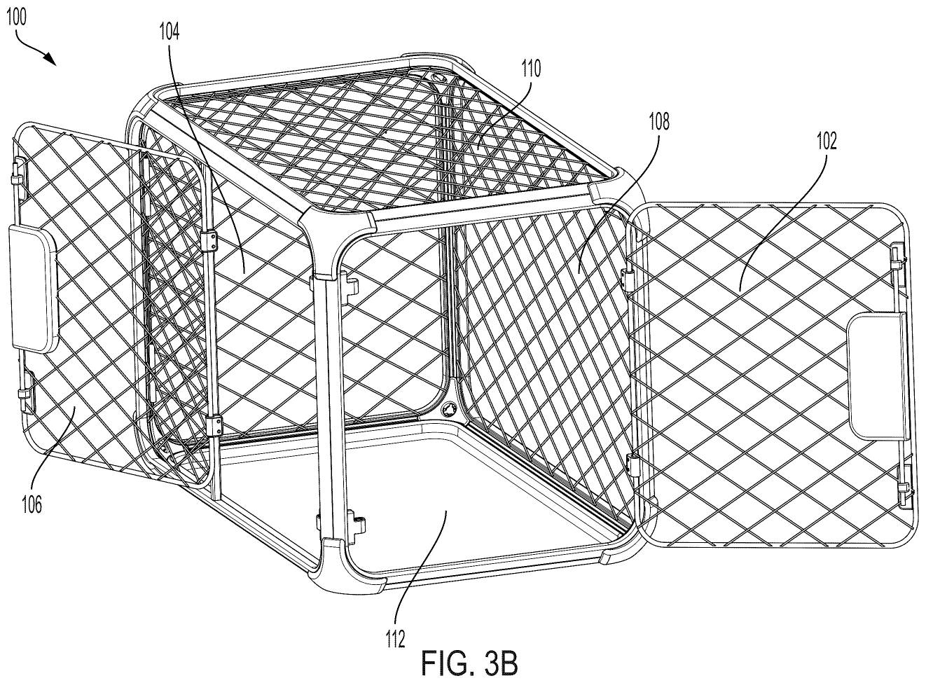

FIGS. 3A and 3B depict the modular animal crate assembly 100 with the side panels arranged in two different orientations. In FIG. 3A, the front side panel 102 is positioned on a front side of the modular animal crate assembly 100 with the door handle and locking mechanism of the door 116 being arranged at a right edge of the front side of the modular animal crate assembly 100. The right side panel 106 is positioned on a right side of the modular animal crate assembly 100 with the door handle and locking mechanism of the door 116 being arranged at a left edge of the right side of the modular animal crate assembly 100.

In FIG. 3B, the front side panel 102 is positioned on a front side of the modular animal crate assembly 100 with the door handle and locking mechanism of the door 116 being arranged at a left edge of the front side of the modular animal crate assembly 100. The right side panel 106 is positioned on a left side of the modular animal crate assembly 100 with the door handle and locking mechanism of the door 116 being arranged at a right edge of the left side of the modular animal crate assembly 100. The ability of the user to choose the positioning of the side panels and doors for the modular animal crate assembly 100 enables the modular animal crate assembly 100 to be customized by the user to best fit the available space where the modular animal crate assembly 100 will be used.

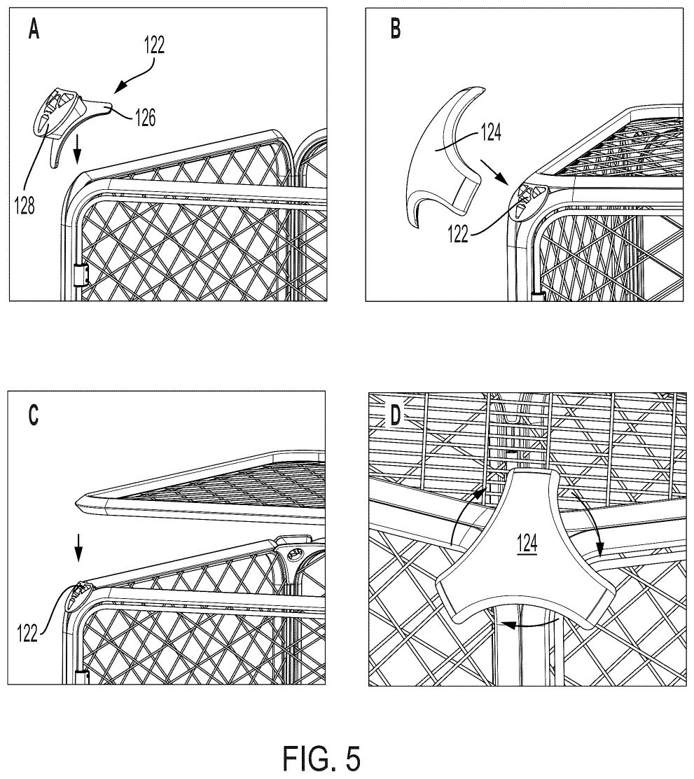

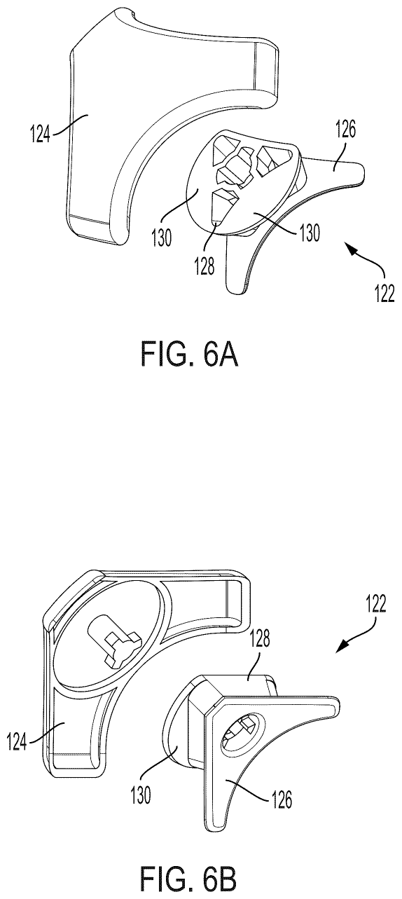

In some embodiments, the various side panels are coupled together using the corner connectors 120 as may be seen in FIGS. 5-6B. For example, the front side panel 102, the rear side panel 104, the right side panel 106, the left side panel 108, the top side panel 110 and the bottom side panel 112 may be coupled together using the corner connectors 120. Each corner connector 120 may be formed from a first connector member 122 and a second connector member 124. In certain embodiments, the second connector member 124 is rotatable relative to the first connector member 122.

When assembling the modular animal crate assembly 100, the first connector member 122 may be positioned at a corner joint between three adjacent side panels, e.g., the front side panel 102, the right side panel 106, and the top side panel 110. In some embodiments, the first connector member 122 includes a securing portion 126, a joint portion 128, and at least one ledge portion 130.

The securing portion 126 may include at least three extension members and may be positioned on an interior side of the modular animal crate assembly 100 when the first connector member 122 is positioned at the corner joint between the three adjacent side panels of the modular animal crate assembly 100. The at least three extension members may align with the edges of the three adjacent side panels. The joint portion 128 may extend through a joint opening formed between the three adjacent side panels when the first connector member 122 is positioned at the corner joint. The at least one ledge portion 130 may extend from the joint portion 128 to form a lip and may abut an outer surface of the frame of at least one of the three adjacent side panels when the first connector member 122 is positioned at the corner joint. The securing portion 126, the joint portion 128, and the at least one ledge portion 130 assist in securing and stabilizing the corner joint between three adjacent side panels.

When assembling the modular animal crate assembly 100, two adjacent panels, e.g., the front side panel 102 and the right side panel 106, may be positioned at a 90 degree angle with an edge of the frame of each panel abutting the other. The securing portion 126 may be positioned at the corner joint formed between the two panels, e.g., as may be seen in block A of FIG. 5. The third adjacent panel may then be positioned to abut an edge of the frame of each of the two positioned, adjacent panels and a portion of the securing portion 126, e.g., as may be seen in block B of FIG. 5. With the three adjacent panels and the securing portion 126 arranged, the second connector member 124 may be coupled to the first connector member 122 to secure the corner joint between the three adjacent side panels of the modular animal crate assembly 100, e.g., as may be seen in block C of FIG. 5.

In some embodiments, the second connector member 124 includes a coupling portion 132 and at least three extension portions 134. When assembling the modular animal crate assembly 100, the second connector member 124 may be coupled to the first connector member 122 that is positioned at the corner joint. For example, the coupling portion 132 may form a protrusion extending from the second connector member 124 that extends at least partially through an opening in the first connector member 122. Rotating the second connector member 124 in a first direction, e.g., clockwise as may be seen in block D of FIG. 5, relative to the first connector member 122 engages a portion of the coupling portion 132 with the first connector member 122 to couple the second connector member 124 to the first connector member 122 and securely lock the corner joint of the modular animal crate assembly 100.

In certain embodiments, the at least three extension portions 134 extend from the second connector member 124 so that when the second connector member 124 is rotated to lock the corner joint, each extension portion of the at least three extension portions 134 extend at least partially along the edge frames of the three adjacent side panels forming the corner joint. For example, at the corner joint between the front side panel 102, the right side panel 106, and the top side panel 110, a first extension portion of the at least three extension portions 134 may extend and at least partially cover the right edge frame of the front side panel 102 and the left edge frame of the right side panel 106. A second extension portion of the at least three extension portions 134 may extend and at least partially cover a top edge frame of the right side panel 106 and a right edge frame of the top side panel 110. A third extension portion of the at least three extension portions 134 may extend and at least partially cover a front edge frame of the top side panel 110 and a top edge frame of the front side panel 102. These extension portions assist in securing the various side panels of the assembled modular animal crate and reduce the ability of animal being able to separate and push through the edges of the various side panels when contained withing the modular animal crate.

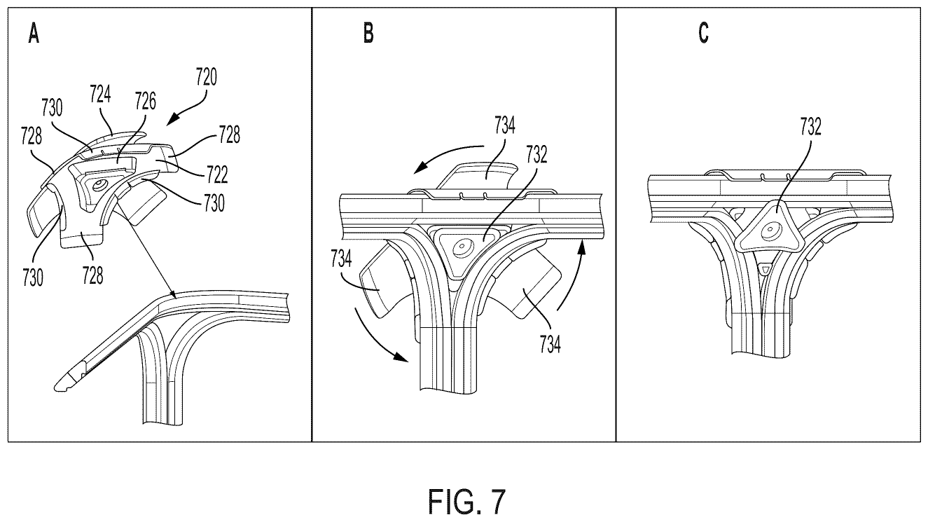

In further embodiments, the first connector member 122 and the second connector member 124 are rotatably fastened together and installed as a single piece when assembling the modular animal crate assembly 100. For example, as may be seen in FIG. 7, a corner connector 720 may be used to couple together the various side panels of the modular animal crate assembly 100. The corner connector 720 may include the same or similar features to the corner connector 120 described above with respect to FIGS. 5-6B.

Each corner connector 720 may be formed from a first connector member 722 and a second connector member 724 that is rotatable relative to the first connector member 722. When assembling the modular animal crate assembly 100, the first connector member 722 and the second connector member 724 may be positioned at a corner joint between three adjacent side panels, e.g., the front side panel 102, the right side panel 106, and the top side panel 110. In some embodiments, the first connector member 722 includes a securing portion 726, at least three extension portions 728, and at least one ledge portion 730.

The securing portion 726 may be shaped to mimic the shape of a joint opening formed between three adjacent side panels so that the securing portion 726 extends at least partially through the joint opening and mates with the frames of the three adjacent side panels of the modular animal crate assembly 100 when the corner connector 720 is positioned at the corner joint. The at least three extension portions 728 may at least partially, and in some embodiments fully, align with and at least partially cover the portions of the frames of the three adjacent side panels at the corner joint. For example, at the corner joint between the front side panel 102, the right side panel 106, and the top side panel 110, a first extension portion of the at least three extension portions 728 may extend and at least partially cover the right edge frame of the front side panel 102 and the left edge frame of the right side panel 106. A second extension portion of the at least three extension portions 728 may extend and at least partially cover a top edge frame of the right side panel 106 and a right edge frame of the top side panel 110. A third extension portion of the at least three extension portions 728 may extend and at least partially cover a front edge frame of the top side panel 110 and a top edge frame of the front side panel 102. These extension portions assist in securing the various side panels of the assembled modular animal crate and reduce the ability of animal being able to separate and push through the edges of the various side panels when contained withing the modular animal crate.

The at least one ledge portion 730 may extend from the first connector member 722 to form at least one lip and may snap fit and/or friction fit with a portion of the frame of at least one of the three adjacent side panels when the first connector member 722 is positioned at the corner joint. In some embodiments, the first connector member 722 includes three ledge portions 730 that each snap fit with a portion of the frame of each respective panel of the three adjacent side panels. The securing portion 726, the at least three extension portions 728, and the at least one ledge portion 730 assist in securing and stabilizing the corner joint between three adjacent side panels. When assembling the modular animal crate assembly 100, the securing portion 726 may be inserted and positioned at least partially within the joint opening at the corner joint formed between three panels and portions of the frames of the three adjacent side panels may be positioned between the securing portion 726 and the at least one ledge portion 730, e.g., as may be seen in blocks A and B of FIG. 7.

In some embodiments, the second connector member 724 includes a coupling portion 732 and at least three extension portions 734 and may be rotatably coupled to the first connector member 722 to form a single piece for the corner connector 720. The coupling portion 732 may be a protrusion that extends from the second connector member 724 and extends at least partially through the first connector member 722.

When assembling the modular animal crate assembly 100, rotating the second connector member 124 in a first direction, e.g., clockwise from the perspective of the user as may be seen in block B of FIG. 7, relative to the first connector member 722 engages a portion of the coupling portion 732 with the a portion of the frame of each respective panel of the three adjacent side panels at the corner joint and securely locks the corner joint of the modular animal crate assembly 100. The engagement of the coupling portion 732 with the portion of the frame of each respective panel reduces the likelihood of the corner connector 720 being inadvertently removed from the corner joint.

In certain embodiments, the at least three extension portions 734 extend from the second connector member 724 so that when the second connector member 724 is rotated to lock the corner joint, each extension portion of the at least three extension portions 734 extend at least partially along the edge frames of the three adjacent side panels forming the corner joint and at least partially, and in some embodiments fully, align with the at least three extension portions 728 of the first connector member 722.

In the following, further examples are described to facilitate the understanding of the invention (and in some aspects, features of an apparatus or system described in one or more of these examples may be utilized in a method described in one of the other examples or vice versa). These examples are not meant to be mutually exclusive, exhaustive, or restrictive; and the disclosure is not limited to these examples but rather encompasses all possible modifications and variations within the scope of the issued claims and their equivalents.

Example 1 is a modular animal crate assembly, which may incorporate features of any of the subsequent examples, comprising: a first side panel comprising a door; a second side panel, a third side panel, a fourth side panel, a fifth side panel, and a sixth side panel; wherein the first side panel, the second side panel, the third side panel, the fourth side panel, the fifth side panel, and the sixth side panel are coupled together to form the modular animal crate assembly; a first assembled state; and a second assembled state; wherein: the first side panel is positioned on a first side of the modular animal crate assembly in the first assembled state; and the first side panel is positioned on a second side of the modular animal crate assembly in the second assembled state.

Example 2 is the modular animal crate assembly of example(s) 1 or any preceding or subsequent example(s) or combination of examples, wherein each of the first side panel, the second side panel, the third side panel, the fourth side panel, the fifth side panel, and the sixth side panel comprises a frame and a mesh network.

Example 3 is the modular animal crate assembly of example(s) 1 or any preceding or subsequent example(s) or combination of examples, further comprising a third assembled state, wherein the door comprises a door opening mechanism positioned at a first edge of the first side of the modular animal crate assembly in the first assembled state, and wherein the first side panel is positioned on the first side of the modular animal crate assembly and the door handle is positioned at a second edge of the first side of the modular animal crate assembly in the third assembled state.

Example 4 is the modular animal crate assembly of example(s) 1 or any preceding or subsequent example(s) or combination of examples, wherein the first side panel is interchangeable with at least one of the second side panel, the third side panel, the fourth side panel, the fifth side panel, or the sixth side panel.

Example 5 is the modular animal crate assembly of example(s) 1 or any preceding or subsequent example(s) or combination of examples, further comprising a corner connector comprising a first connector member and a second connector member rotatably coupleable to the first connector member, wherein the corner connector secures a corner joint formed between three panels of the first side panel, the second side panel, the third side panel, the fourth side panel, the fifth side panel, and the sixth side panel.

Example 6 is the modular animal crate assembly of example(s) 5 or any preceding or subsequent example(s) or combination of examples, wherein at least a first portion of the corner connector is arranged on an interior surface of the modular animal crate assembly and at least a second portion of the corner connector is arranged on an exterior surface of the modular animal crate assembly.

Example 7 is the modular animal crate assembly of example(s) 5 or any preceding or subsequent example(s) or combination of examples, wherein at least one of the first connector member or the second connector member comprises at least three extension portions that extend at least partially along an edge of each of the three panels that form the corner joint.

Example 8 is a modular animal crate assembly, which may incorporate features of any of the preceding or subsequent examples, comprising: a front side panel comprising a first door comprising a door opening mechanism; a rear side panel; a right side panel comprising a second door; a left side panel; a top side panel; a bottom side panel; a first assembled state, wherein, in the first assembled state, the front side panel is positioned on a front side of the modular animal crate assembly, the door opening mechanism is positioned at a first edge of the front side of the modular animal crate assembly, and the right side panel is positioned on a right side of the modular animal crate assembly; and a second assembled state, wherein, in the second assembled state, the front side panel is positioned on a front side of the modular animal crate assembly, the door opening mechanism is positioned at a second edge of the front side of the modular animal crate assembly, and the right side panel is positioned on a left side of the modular animal crate assembly.

Example 9 is the modular animal crate assembly of example(s) 8 or any preceding or subsequent example(s) or combination of examples, wherein each of the front side panel, the rear side panel, the right side panel, the left side panel, the top side panel, and the bottom side panel comprises a frame and a mesh network.

Example 10 is the modular animal crate assembly of example(s) 8 or any preceding or subsequent example(s) or combination of examples, wherein the front side panel and the rear side panel are interchangeable.

Example 11 is the modular animal crate assembly of example(s) 8 or any preceding or subsequent example(s) or combination of examples, wherein the right side panel, the left side panel, the top side panel, and the bottom side panel are interchangeable.

Example 12 is the modular animal crate assembly of example(s) 8 or any preceding or subsequent example(s) or combination of examples, further comprising a corner connector comprising a first connector member and a second connector member rotatably coupleable to the first connector member, wherein the corner connector secures a corner joint formed between three adjacent panels of the front side panel, the rear side panel, the right side panel, the left side panel, the top side panel, and the bottom side panel.

Example 13 is the modular animal crate assembly of example(s) 12 or any preceding or subsequent example(s) or combination of examples, wherein at least a first portion of the corner connector is arranged on an interior surface of the modular animal crate assembly and at least a second portion of the corner connector is arranged on an exterior surface of the modular animal crate assembly.

Example 14 is the modular animal crate assembly of example(s) 12 or any preceding or subsequent example(s) or combination of examples, wherein at least one of the first connector member or the second connector member comprises at least three extension portions that extend at least partially along an edge of each of the three adjacent panels that form the corner joint.

Example 15 is a method, which may incorporate features of any of the preceding or subsequent examples, of assembling a modular animal crate assembly comprising a first side panel; a second side panel, a third side panel, a fourth side panel, a fifth side panel, a sixth side panel, and a corner connector, the method comprising: positioning the first side panel, the second side panel, and the third side panel adjacent to one another to form a corner joint; inserting at least a first portion of the corner connector through an opening in the corner joint; and rotating at least a second portion of the corner connecter to couple the corner connector to the corner joint.

Example 16 is the method of example(s) 15 or any preceding or subsequent example(s) or combination of examples, positioning the fourth side panel, the fifth side panel, and the sixth side panel to form an additional seven corner joints; inserting at least a first portion of each of an additional seven corner connectors through an opening in each of the additional seven corner joints, respectively; and rotating at least a second portion of each of the additional seven corner connectors to couple the additional seven corner connectors to the additional seven corner joints, respectively.

Example 17 is the method of example(s) 15 or any preceding or subsequent example(s) or combination of examples, further comprising repositioning the first side panel from a first side of the modular animal crate assembly to a second side of the modular animal crate assembly.

Example 18 is the method of example(s) 15 or any preceding or subsequent example(s) or combination of examples, wherein the first side panel comprises a door comprising a door opening mechanism positioned at a first edge of a first side of the modular animal crate assembly.

Example 19 is the method of example(s) 18 or any preceding or subsequent example(s) or combination of examples, further comprising rotating the first side panel to move the door opening mechanism from the first edge of the first side of the modular animal crate assembly to a second edge of the first side of the modular animal crate assembly.

Example 20 is the method of example(s) 15 or any preceding example(s) or combination of examples, wherein the corner connector comprises at least three extension portions, and rotating at least the second portion of the corner connector aligns the at least three extension portions with an edge of each of the first side panel, the second side panel, and the third side panel at the corner joint.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

1. A modular animal crate assembly comprising:
a first side panel comprising a door; a second side panel, a third side panel, a fourth side panel, a fifth side panel, and a sixth side panel; wherein the first side panel, the second side panel, the third side panel, the fourth side panel, the fifth side panel, and the sixth side panel are coupled together to form the modular animal crate assembly;
a corner connector comprising a first connector member and a second connector member rotatably coupleable to the first connector member; wherein the corner connector secures a corner joint formed between three panels of the first side panel, the second side panel, the third side panel, the fourth side panel, the fifth side panel, and the sixth side panel; and wherein the second connector member is rotatable relative to the first connector member while the corner connector is secured at the corner joint;
a first assembled state; and
a second assembled state; wherein:
the first side panel is positioned on a first side of the modular animal crate assembly in the first assembled state; and
the first side panel is positioned on a second side of the modular animal crate assembly in the second assembled state.

2. The modular animal crate assembly of claim 1, wherein each of the first side panel, the second side panel, the third side panel, the fourth side panel, the fifth side panel, and the sixth side panel comprises a frame and a mesh network.

3. The modular animal crate assembly of claim 1, further comprising a third assembled state, wherein the door comprises a door opening mechanism positioned at a first edge of the first side of the modular animal crate assembly in the first assembled state, and wherein the first side panel is positioned on the first side of the modular animal crate assembly and the door opening mechanism is positioned at a second edge of the first side of the modular animal crate assembly in the third assembled state.

4. The modular animal crate assembly of claim 1, wherein the first side panel is interchangeable with at least one of the second side panel, the third side panel, the fourth side panel, the fifth side panel, or the sixth side panel.

5. The modular animal crate assembly of claim 1, wherein a first portion of the second connector member is arranged on an interior surface of the modular animal crate assembly and a second portion of the second connector member is arranged on an exterior surface of the modular animal crate assembly.

6. The modular animal crate assembly of claim 5, wherein the second portion of the second connector member extends at least partially through the first connector member.

7. The modular animal crate assembly of claim 1, wherein at least one of the first connector member or the second connector member comprises at least three extension portions that extend at least partially along an edge of each of the three panels that form the corner joint.

8. A modular animal crate assembly comprising:
a front side panel comprising a first door comprising a door opening mechanism;
a rear side panel;
a right side panel comprising a second door;
a left side panel;
a top side panel;
a bottom side panel;
a corner connector comprising a first connector member and a second connector member rotatably coupleable to the first connector member, wherein the corner connector secures a corner joint formed between three adjacent panels of the front side panel, the rear side panel, the right side panel, the left side panel, the top side panel, and the bottom side panel; and wherein the second connector member is rotatable relative to the first connector member while the corner connector is secured at the corner joint;
a first assembled state, wherein, in the first assembled state, the front side panel is positioned on a front side of the modular animal crate assembly, the door opening mechanism is positioned at a first edge of the front side of the modular animal crate assembly, and the right side panel is positioned on a right side of the modular animal crate assembly; and
a second assembled state, wherein, in the second assembled state, the front side panel is positioned on a front side of the modular animal crate assembly, the door opening mechanism is positioned at a second edge of the front side of the modular animal crate assembly, and the right side panel is positioned on a left side of the modular animal crate assembly.

9. The modular animal crate assembly of claim 8, wherein each of the front side panel, the rear side panel, the right side panel, the left side panel, the top side panel, and the bottom side panel comprises a frame and a mesh network.

10. The modular animal crate assembly of claim 8, wherein the front side panel and the rear side panel are interchangeable.

11. The modular animal crate assembly of claim 8, wherein the right side panel, the left side panel, the top side panel, and the bottom side panel are interchangeable.

12. The modular animal crate assembly of claim 8, wherein a first portion of the second connector member is arranged on an interior surface of the modular animal crate assembly and a second portion of the second connector member is arranged on an exterior surface of the modular animal crate assembly.

13. The modular animal crate assembly of claim 12, wherein the second portion of the second connector member extends at least partially through the first connector member.

14. The modular animal crate assembly of claim 8, wherein at least one of the first connector member or the second connector member comprises at least three extension portions that extend at least partially along an edge of each of the three adjacent panels that form the corner joint.

15. A method of assembling a modular animal crate assembly comprising a first side panel; a second side panel, a third side panel, a fourth side panel, a fifth side panel, a sixth side panel, and a corner connector, the method comprising:
positioning the first side panel, the second side panel, and the third side panel adjacent to one another to form a corner joint;
inserting at least a first portion of the corner connector through an opening in the corner joint; and
rotating at least a second portion of the corner connecter to couple the corner connector to the corner joint.

16. The method of claim 15, positioning the fourth side panel, the fifth side panel, and the sixth side panel to form an additional seven corner joints; inserting at least a first portion of each of an additional seven corner connectors through an opening in each of the additional seven corner joints, respectively; and rotating at least a second portion of each of the additional seven corner connectors to couple the additional seven corner connectors to the additional seven corner joints, respectively.

17. The method of claim 15, further comprising repositioning the first side panel from a first side of the modular animal crate assembly to a second side of the modular animal crate assembly.

18. The method of claim 15, wherein the first side panel comprises a door comprising a door opening mechanism positioned at a first edge of a first side of the modular animal crate assembly.

19. The method of claim 18, further comprising rotating the first side panel to move the door opening mechanism from the first edge of the first side of the modular animal crate assembly to a second edge of the first side of the modular animal crate assembly.

20. The method of claim 15, wherein the corner connector comprises at least three extension portions, and rotating at least the second portion of the corner connector aligns the at least three extension portions with an edge of each of the first side panel, the second side panel, and the third side panel at the corner joint.
